(19) United States
(12) Patent Application Publication
(10) Pub. No.: US 2010/0020566 A1
(43) Pub. Date: Jan. 28, 2010

(54) Light guild plate structure and backlight module using the same

(75) Inventor: Tun-Chien Teng, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/458,472

(22) Filed: Jul. 14, 2009

(30) Foreign Application Priority Data
Jul. 24, 2008 (TW) 097128066

(51) Int. Cl. F21V 8/00

(52) U.S. Cl. 362/606; 362/617

(57) ABSTRACT

A light guide plate structure including a main body, a low-refraction index layer, and a collimation lens film is provided. The main body has a side incident surface on a sidewall thereof. The low-refraction index layer is bonded to an upper surface of the main body. A refraction index of the low-refraction index layer is smaller than a refraction index of the main body. The low-refraction index layer has a plurality of through holes therein. The through holes are filled with a material, and the refraction index of the material is close to the refraction index of the main body. The collimation lens film is disposed on an upper surface of the low-refraction index layer and has a plurality of lens structures aligned to the through holes respectively for transforming a light beam entering the collimation lens film via the through holes into a parallel light beam projecting upward.

### BACKGROUND OF THE INVENTION

(1) Field of the Invention

This invention relates to a backlight module, and more particularly relates to a light guide plate structure of the backlight module.

(2) Description of the Prior Art

Liquid crystal display technology is a display technology featuring a backlight source to provide light for the light crystal display panel to image. Generally, to enhance image brightness and uniformity, light beams from the backlight source may have enough brightness and uniformity.

FIG. 1 is a schematic explosive view of a typical side lighting backlight module 100. Referring to FIG. 1, the backlight module 100 has a light source 110, a light guide plate 120, a collimation lens film 130, a brightness enhance plate 140, and an upper diffusion plate 150. The light source 110 is disposed by a side of the light guide plate 120. The collimation lens film 130, the brightness enhance plate 140, and the upper diffusion plate 150 are stacked on an upper surface of the light guide plate 120 in a serial. Light beams from the light source 110 enter the light guide plate 120 from a side surface thereof and emit from the upper surface of the light guide plate 120 after several times of refraction or reflection.

Noticeably, only a part of the light beams emitting from the upper surface of the light guide plate 120 is in the direction V perpendicular to the light guide plate 120. Thus, the vertical illumination from the light guide plate may not provide enough brightness for the display panel (not shown). To enhance brightness in the direction V, the collimation lens film 130 is disposed right on the upper surface of the light guide plate 120 to transform inclined light beams into upward light beams.

FIG. 2 is a cross-sectional view of a typical collimation lens film 130. As shown, the collimation lens film 130 has a substrate 132, a metal reflection layer 136, a plurality of lenses 134, and a plurality of incident holes 138. The metal reflection layer 136 is disposed on a lower surface of the substrate 132. The incident holes 138 are formed in the metal reflection layer 136 as routes for light beams entering the collimation lens film 130 from the light guide plate 120. The lenses 134 are disposed on an upper surface of the substrate 132 and aligned to the incident holes 138 on the lower surface of the substrate 132 respectively. The incident holes 138 are substantially disposed at a focus of the corresponding lens 134. Thus, light beams A1 entering the collimation lens film 130 through the incident holes 138 are transformed into parallel light beams A2 after the refraction of the lens 134.

Noticeably, collimation level of the parallel light beams A2 emitting from the collimation lens film 130 depends on a size of the incident hole 138. If the incident hole 138 may be regarded as a point light source, the light beams from the incident hole 138 are transformed by the lens 134 into parallel light beams A2. However, with the increasing of the size of the incident hole 138, collimation level of the parallel light beams A2 from the lens 134 of the collimation lens film 130 becomes worse.

Next, the lower surface of the collimation lens film 130 is covered by the metal reflection layer 136. Among the light beams emitted from the upper surface of the light guide plate 120, the light beams A1 directed to the incident hole 138 may penetrate the metal reflection layer 136 into the collimation lens film 130. The other light beams A3 are reflected by the metal reflection layer 136 back into the light guide plate 120. During the reflection, part of the energy of the light beams is absorbed by the metal reflection layer 136. With the decreasing of the size of the incident hole 138, the chance of the light beams emitted from the upper surface of the light guide plate 120 being reflected by the metal reflection layer 136 increases. Thus, the number that light beams reflected in the light guide plate 120 before entering the collimation lens film 130 is increased, and may lower down light efficiency of the backlight module 100.

In conclusion, although collimation level of the light beams emitted from the collimation lens 130 may be enhanced by reducing the size of the incident hole 138, the number that light beams reflected in the light guide plate 120 before entering the collimation lens film would be also increased to cause lower light efficiency.

### SUMMARY OF THE INVENTION

The invention is to provide a light guide plate structure of a backlight module capable of integrating the light guide plate and the collimation lens film to enhance light efficiency of the backlight module as well as collimation of a light beam.

A light guide plate structure is provided in an embodiment of the invention. The light guide plate structure includes a main body, a low-refraction index layer, and a collimation lens film. The main body has a side incident surface on a sidewall thereof. The low-refraction index layer is bonded to an upper surface of the main body. The low-refraction index layer has a refraction index smaller than a refraction index of the main body and has a plurality of through holes therein. The through holes are filled with a material, and a refraction index of the material is close to the refraction index of the main body. The collimation lens film is disposed on an upper surface of the low-refraction index layer and has a plurality of lens structures aligned to the through holes of the low-refraction index layer respectively for transforming a light beam entering the collimation lens film via the through holes into a parallel light beam.

In an embodiment of the invention, the light guide plate structure further has a metal reflection layer is interposed between the collimation lens film and the low-refraction index layer. The metal reflection layer has a plurality of openings aligned to the through holes respectively. The light beam from the main body enters the collimation lens film via the through holes of the low-refraction index layer and the corresponding openings.

In an embodiment of the invention, the low-refraction index layer is a transparent layer having a plurality of small air holes distributed therein.

In an embodiment of the invention, the lens structure of the collimation lens film is sphere in shape or column in shape.

In an embodiment of the invention, the light guide plate structure further has a diffusion layer interposed between the collimation lens film and the low-refraction index layer to enhance light uniformity.

The lower surface of the traditional collimation lens film is covered by the metal reflection layer with a plurality of incident holes. During the reflection, part of the energy of the light beams is absorbed by the metal reflection layer. Therefore, although the collimation level of the light beam may be enhanced by decreasing a size of the incident hole, the number that the light beam reflected in the light guide plate before entering the collimation lens film is also increased, and lowers down light efficiency of the backlight module.

In comparison, in the embodiment of the invention, the upper surface of the main body is bonded to the low-refraction index layer. Total reflection at the interface between the main body and the low-refraction index layer would not consume light energy. Thus, the size of the through hole in the low-refraction index layer may be shrunk down to enhance the collimation level of the light beam projecting upward from the collimation lens film without the need of considering the potential side effect of low light efficiency due to small through hole.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The invention will now be specified with reference to its embodiment illustrated in the drawings, in which

FIG. 1 is a schematic explosive view of a typical backlight module;

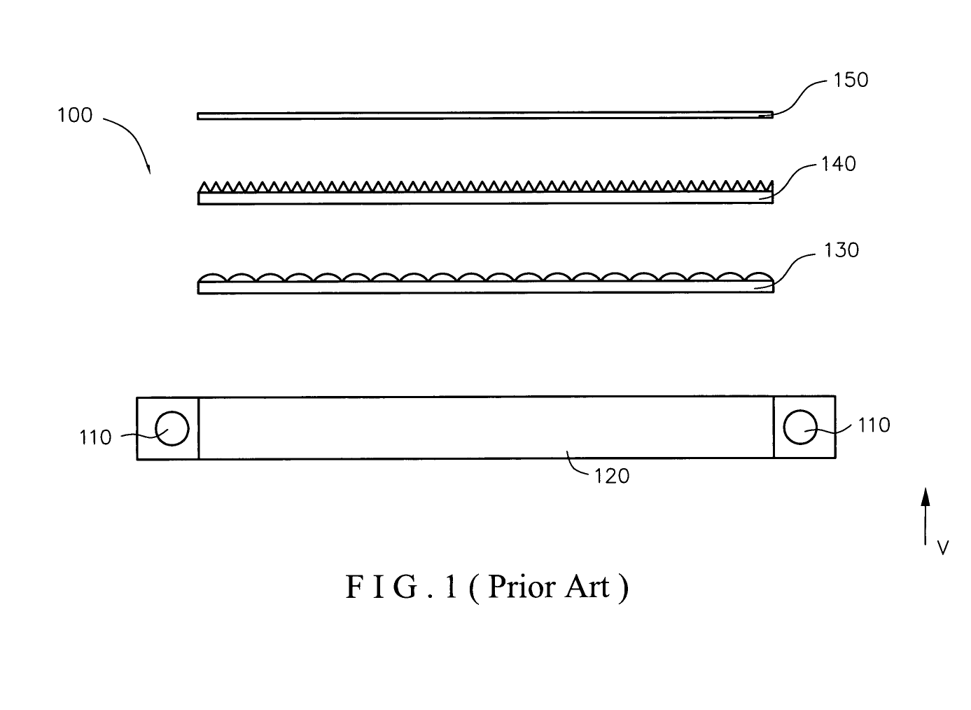

FIG. 2 is a schematic view of a typical collimation lens film;

FIG. 3 is a schematic view of an embodiment of the backlight module according to the invention;

FIG. 4 is an enlarged schematic view of the light guide plate structure in FIG. 3;

FIG. 5 is a schematic view of another embodiment of the light guide plate structure according to the invention;

FIG. 6 is a schematic view of another embodiment of the light guide plate structure according to the invention; and

FIGS. 7A and 7B are schematic views of two embodiments of the through hole in the low-refraction index layer of the light guide plate according to the invention.

### DESCRIPTION OF THE PRESENT EMBODIMENTS

In the following detailed description of the present embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

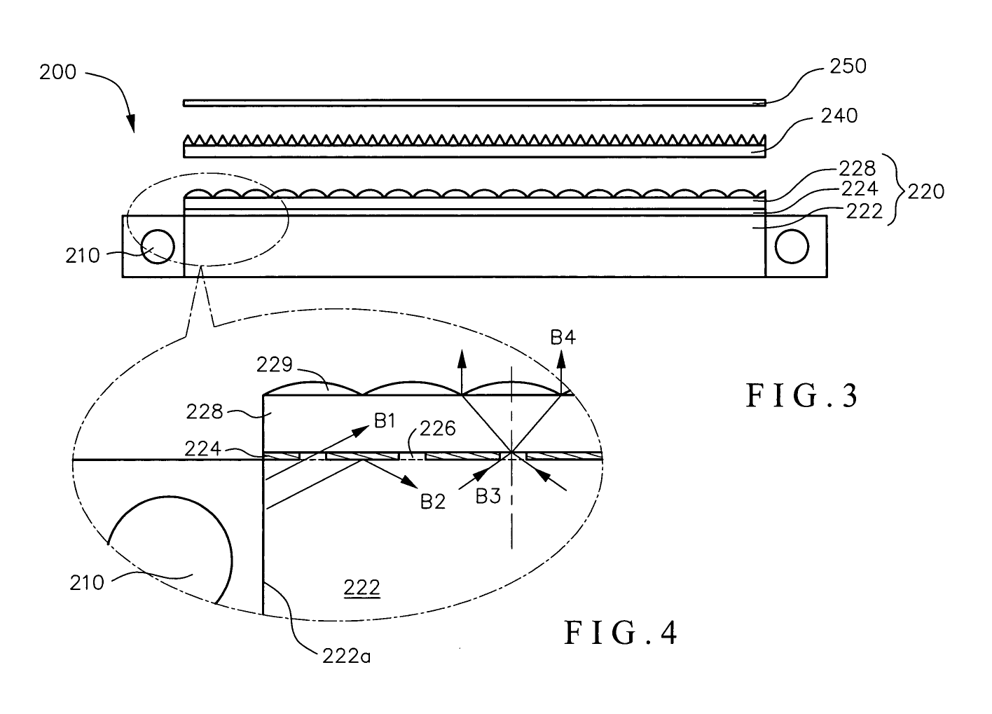

FIG. 3 is a schematic view of an embodiment of the backlight module 200 according to the invention. As shown in FIG. 3, the backlight nodule 200 includes a light source 210, a light guide plate structure 220, a brightness enhance plate 240, and a diffusion film 250. The light source 210 is disposed by a side of the light guide plate structure 220. In other words, the backlight module 200 in the embodiment is a side lighting backlight module. The brightness enhance plate 240 and the diffusion film 250 are stacked above the light guide plate structure 220 in a serial to enhance brightness and uniformity of the light beam projecting upward from the light guide plate structure 220. However, the brightness enhance plate 240 and the diffusion film 250 introduced in this embodiment are not intended to limit the invention. Whether it is necessary or not to use the brightness enhance plate 240 or the diffusion film 250 inside the backlight module 200 depends on the required brightness and viewing angle.

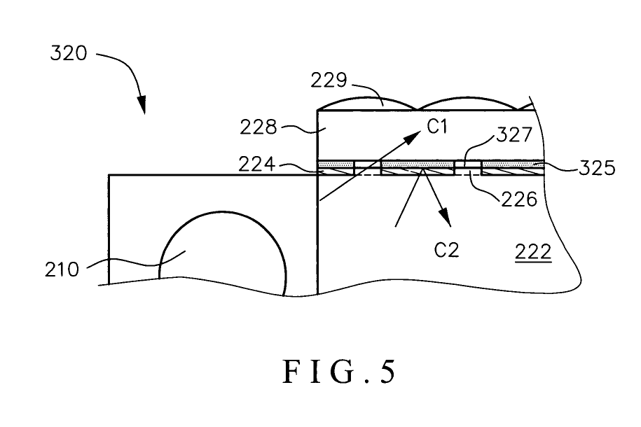

FIG. 4 is an enlarged schematic view of the light guide plate structure 220 in FIG. 3. As shown in FIG. 4, the light guide plate structure 220 includes a main body 222, a low-refraction index layer 224, and a collimation lens film 228. The main body 222 has a side incident surface 222a on a sidewall thereof. Light beams from the light source 210 enter the main body 222 via the side incident surface 222a. The low-refraction index layer 224 is bonded to an upper surface of the main body 222. The refraction index of the low-refraction index layer 224 is smaller than the refraction index of the main body 222.

For a embodiment, the refraction index of the main body 222 is about 1.4 to 1.6 and the refraction index of the low-refraction index layer 224 is about 1.1 to 1.3. For example, the low-refraction index layer 224 may be a transparent layer having a plurality small air holes distributed therein. Moreover, the transparent material including the low-refraction index layer 224 may be used the same material of the main body 222.

The low-refraction index layer 224 has a plurality of through holes 226 therein. The through holes 226 are filled with a material, and a refraction index of the material is close to the refraction index of the main body 222. The collimation lens film 228 is disposed on an upper surface of the low-refraction index layer 224. The collimation lens film 228 has a plurality of lens structures 229 on an upper surface thereof, and the lens structures 229 are aligned to the through holes 226 of the low-refraction index layer 224 respectively. The lens structures 229 are utilized for transforming light beams B3 entering the collimation lens film 228 via the through holes 226 into parallel light beams B4 projecting upward.

For an embodiment, the collimation lens film 228 is bonded to the upper surface of the low-refraction index layer 224 directly to ensure the lens structure 229 of the collimation lens film 228 aligned to the through holes 226 in the low-refraction index layer 224 respectively. Moreover, in the embodiment, the lens structure 229 is sphere in shape. It is not intended to limit the scope of the invention. The lens structure 229 may also be column in shape or adopt aspheric lens design.

As FIG. 4 shows, for the refraction index of the low-refraction index layer 224 is smaller than the refraction index of the main body 222, as the incident angle of the light beam B2 at the interface between the main body 222 and the low-refraction index layer 224 is smaller than critical angle of total reflection, the light beams B2 may enter the collimation lens film 228 by penetrating the low-refraction index layer 224. If not, the light beam would be totally reflected back to the main body 222. In another aspect, the through holes 226 are filled with the material, and the refraction index of the material close to the refraction index of the main body 222. Therefore, the light path of the light beam is not bended between the through hole 226 and the main body 222, and the light beam B1 may enter the collimation lens film 228 via the through holes 226 directly.

For an embodiment, as the refraction index of the low-refraction index layer 224 is 1.2 and the refraction index of the main body 222 is 1.55, and the light source 210 generates light of Lambertian distribution entering the main body 222. Light beam from the light source 210 entering the main body 222 is ranged between ±40° from the normal direction of the side incident surface 222a. In addition, the critical angle of total reflection at the interface between the main body 222 and the low-refraction index layer 224 is 50.7°. Under this circumstance, only the light beam B1 aiming the through holes 226 may penetrate the low-refraction index layer 224 to the collimation lens film 228, most of the light beams B2 projecting to the interface between the main body 222 and the low-refraction index layer 224 are reflected back to the main body 222 undergoing a total internal reflection at the interface. Thus, most of the light beams from the side incident surface 222a enter the collimation lens film 228 via the through holes 226 and further transformed into parallel light beams projecting upward by the lens structures 229 of the collimation lens film 228.

Subsequently, collimation level of the light beams from the lens structures 229 of the collimation lens film 228 depends on a position and a size of the through hole 226. For an embodiment, the exit opening of the through hole 226 is disposed approximately at a focus of the corresponding lens structure 229. Moreover, sum of an area of the exit openings of the through holes 226 is smaller than ⅓ of an area of the upper surface of the low-refraction index layer 224.

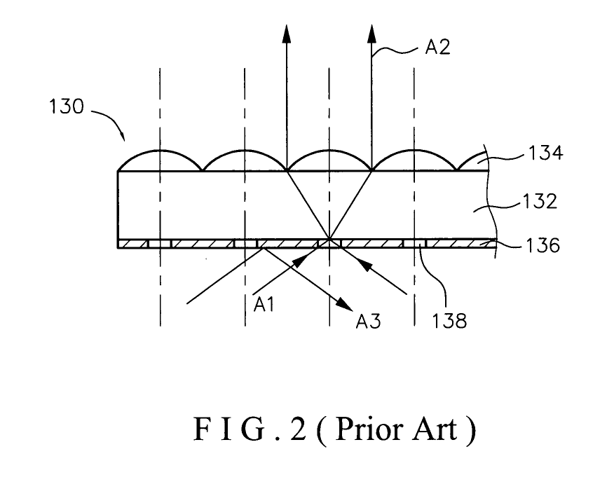

As FIG. 2 shows, the lower surface of the traditional collimation lens film 130 is covered by the metal reflection layer 136, and the metal reflection layer 136 has a plurality of incident holes 138 as optical routes for the light beams entering the collimation lens film 130. As to the traditional collimation lens film 130, although the collimation level of the light beams may be enhanced by decreasing the size of the incident hole, the number that the light beams reflected in the light guide plate 120 before entering the collimation lens film 130 is increased, and lowers down light efficiency of the backlight module 100.

In comparison, as FIG. 4 shows, the upper surface of the main body 222 is bonded to the low-refraction index layer 224 in the embodiment. Total reflection at the interface between the main body 222 and the low-refraction index layer 224 would not consume light energy. Thus, the size of the through hole 226 in the low-refraction index layer 224 may be further shrunk down for enhancing the collimation level of the light beams projecting upward from the collimation lens film 228, without the need of considering the potential side effect of low light efficiency due to small through hole 226.

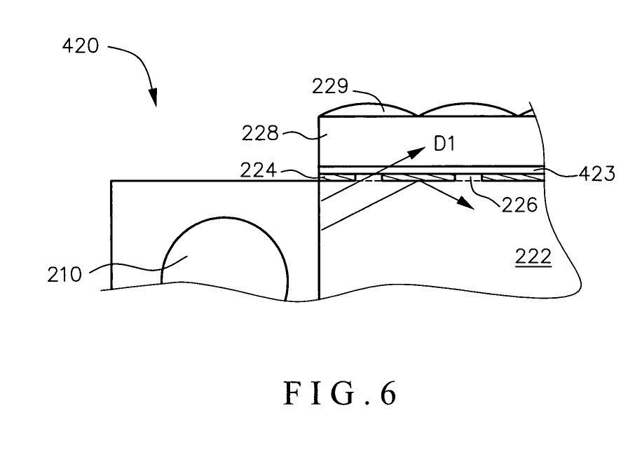

FIG. 5 is another embodiment of the light guide plate structure 320 according to the invention. Comparing to the light guide plate structure 220 in FIG. 4, the light guide plate structure 320 of the embodiment has a metal reflection layer 325 interposed between the collimation lens film 228 and the low-refraction index layer 224. The metal reflection layer 325 has a plurality of openings 327 aligned to the through holes 226 in the low-refraction index layer 224 respectively. Light beams C1 entering the through holes 226 may pass through the openings 327 in the metal reflection layer 325 to the collimation lens film 228. The small portion of light beams C2 entering the low-refraction index layer 224 by penetrating the interface between the main body 222 and the low-refraction index layer 224 are reflected back to the main body 222 by the metal reflection layer 325. Hence, comparing to the embodiment in FIG. 4, the light guide plate structure 320 in the embodiment may further ensure the light beams from the main body 222 entering the collimation lens film 228 only through the through holes 226 in the low-refraction index layer 224 and the corresponding openings 327.

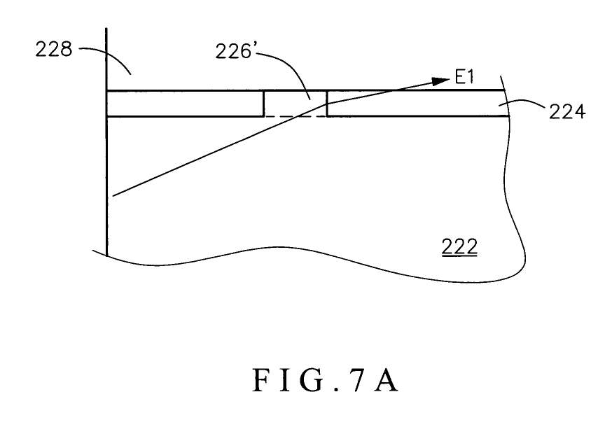

FIG. 6 is a schematic view of another embodiment of the light guide plate structure 420 according to the invention. Comparing to the light guide plate structure 220 in FIG. 4, the light guide plate structure 420 in the embodiment has a light diffusion layer 423 interposed between the collimation lens film 228 and the low-refraction index layer 224 for improving uniformity of light beams D1 entering the collimation lens film 228 through the through holes 226.

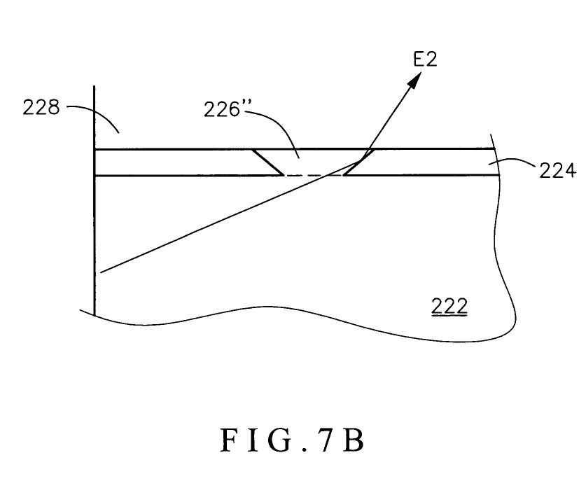

FIGS. 7A and 7B are schematic views showing two embodiments of the through holes 226′ and 226″ in the low-refraction index layer 224 of the light guide plate 220 according to the invention. As shown, the through hole 226′ of FIG. 7A has a consistent diameter from top to bottom, while the through holes 226″ of FIG. 7B is conical in shape with a structure of wide top and narrow bottom. As FIG. 7A shows, with a consistent diameter, the chance of the light beams E1 entering to the low-refraction index layer 224 that the incident angle of light beams E1 entering the through hole 226′ being smaller than the critical angle of total reflection at the interface between the filling stuff of the through hole 226′ and the low-refraction index layer 224 is much greater than the chance of the through holes 226″ of FIG. 7B with a conical profile. That is, the percentage of light beams E1 totally reflected in the through hole 226″ is much higher than the percentage of light beams E1 totally reflected in the through hole 226′. Thus, the conical through hole 226″ may further ensure the light beams from the main body 222 entering the low-refraction index layer 224 only through the through hole 226″.

The foregoing description of the present embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate structure, comprising:
a main body, having a side incident surface;
a low-refraction index layer, bonded to an upper surface of the main body, a refraction index of the low-refraction index layer being smaller than a refraction index of the main body, the low-refraction index layer having a plurality of through holes therein, the through holes being filled with a material, and a refraction index of the material being close to the refraction index of the main body; and
a collimation lens film, disposed on an upper surface of the low-refraction index layer, the collimation lens film comprising a plurality of lens structures aligned to the through holes respectively for transforming a light beam entering the collimation lens film via the through holes into a parallel light beam.

2. The light guide plate structure of claim 1, wherein the collimation lens film is capable of being bonded to the upper surface of the low-refraction index layer.

3. The light guide plate structure of claim 1, wherein an exit opening of the through hole is approximately disposed at a focus of the corresponding lens structure.

4. The light guide plate structure of claim 1, wherein sum of an area of the exit openings of the through holes is smaller than ⅓ of an area of the upper surface of the low-refraction index layer.

5. The light guide plate structure of claim 1, further comprising a metal reflection layer interposed between the collimation lens film and the low-refraction index layer, the metal reflection layer having a plurality of openings aligned to the through holes respectively, and the light beam from the main body entering the collimation lens film via the through holes and the corresponding openings.

6. The light guide plate structure of claim 1, further comprising a diffusion layer interposed between the collimation lens film and the low-refraction index layer to enhance light uniformity.

7. The light guide plate structure of claim 1, wherein the low-refraction index layer is a transparent layer having a plurality of small air holes distributed therein.

8. The light guide plate structure of claim 1, wherein the lens structure is sphere in shape or column in shape.

9. The light guide plate structure of claim 1, wherein the refraction index of the main body is about 1.4 to 1.6 and the refraction index of the low-refraction index layer is about 1.1 to 1.3.

10. A backlight module, including:
a light source;
a light guide plate structure, the light source being disposed by a side of the light guide plate structure, comprising:
a main body, having a side incident surface on a sidewall thereof, a light beam from the light source entering the main body via the side incident surface;
a low-refraction index layer, bonded to an upper surface of the main body, a refraction index of the low-refraction index layer being smaller than a refraction index of the main body, the low-refraction index layer having a plurality of through holes therein, the through holes being filled with a material, and a refraction index of the material being close to the refraction index of the main body; and
a collimation lens film, disposed on an upper surface of the low-refraction index layer, the collimation lens film comprising a plurality of lens structures aligned to the through holes respectively for transforming a light beam entering the collimation lens film via the through holes into a parallel light beam; and
a diffusion film, disposed above the light guide plate structure to enhance uniformity of the light beam from the light guide plate structure.

11. The backlight module of claim 10, wherein the collimation lens film is capable of being bonded to the upper surface of the low-refraction index layer.

12. The backlight module of claim 10, wherein an exit opening of the through hole is approximately disposed at a focus of the corresponding lens structure.

13. The backlight module of claim 10, wherein sum of an area of the exit openings of the through holes is smaller than ⅓ of an area of the upper surface of the low-refraction index layer.

14. The backlight module of claim 10, further comprising a metal reflection layer interposed between the collimation lens film and the low-refraction index layer, the metal reflection layer having a plurality of openings aligned to the through holes respectively, and the light beam from the main body entering the collimation lens film via the through holes and the corresponding openings.

15. The backlight module of claim 10, further comprising a diffusion layer interposed between the collimation lens film and the low-refraction index layer to enhance light uniformity.

16. The backlight module of claim 10, wherein the low-refraction index layer is a transparent layer having a plurality of small air holes distributed therein.

17. The backlight module of claim 10, wherein the lens structure is sphere in shape or column in shape.

18. The backlight module of claim 10, wherein the refraction index of the main body is about 1.4 to 1.6 and the refraction index of the low-refraction index layer is about 1.1 to 1.3.
